(19) United States
(12) Patent Application Publication
(10) Pub. No.: US 2020/0221115 A1
(43) Pub. Date: Jul. 9, 2020

(54) Syntax-based Method of Extracting Region of Moving Object in Compressed Video

(71) Applicant: INNODEP CO., LTD., Seoul (KR)

(72) Inventors: Hyun Woo LEE, Seoul (KR); Hyun Seong BAE, Seoul (KR); Sung Jin LEE, Gwangmyeong-si (KR)

(21) Appl. No.: 16/641,198

(22) PCT Filed: Dec. 1, 2017
(86) PCT No.: PCT/KR2017/013970

§ 371 Date: Feb. 21, 2020

(30) Foreign Application Priority Data
Aug. 24, 2017 (KR) 10-2017-0107580

(51) Int. Cl. H04N 19/52; H04N 19/593; H04N 19/70; H04N 19/176; H04N 19/184

(52) U.S. Cl. CPC H04N 19/52; H04N 19/593; H04N 19/184; H04N 19/176; H04N 19/70

(57) ABSTRACT

The present invention relates to a technology of effectively extracting regions of moving object in compressed video, e.g., H.264 AVC or H.265 HEVC, etc. More specifically, the present invention relates to a technology of extracting regions of moving object in compressed, regions in which substantial movement exists, based on syntax information, e.g., motion vector and coding type, without conventional complicated image processing such as video stream decoding or image analysis, which renders the efficiency of extracting regions of moving object improved. The present invention may provide an advantage of effectively extracting regions of moving object in compressed video, e.g., CCTV cameras generating. The present invention may provide more or less 20 times better performance than conventional video analysis servers by extracting regions of moving object without complicated processing such as video decoding, downscale resizing, differential image obtaining, and image analysis, etc.

### FIELD OF THE INVENTION

The present invention generally relates to a technology of effectively extracting regions of moving object in compressed video, e.g., H.264 AVC or H.265 HEVC, etc.

More specifically, the present invention relates to a technology of extracting regions of moving object in compressed, regions in which substantial movement exists, based on syntax information, e.g., motion vector and coding type, without conventional complicated image processing such as video stream decoding or image analysis, which renders the efficiency of extracting regions of moving object improved.

### BACKGROUND ART

In general, image processing systems may encode or decode video by a technical specification such as MPEG-1/2/4, H.264 AVC, H.265 HEVC, etc. The camera devices shall produce and provide video data in a form of compressed video by any one of the technical standards as above. Then, video replay devices shall receive the compressed video and then perform decoding by the technical standard which has been used in encoding the compressed video.

FIG. 1 is a block diagram illustrating the general constitution of a video decoding apparatus according to H.264 AVC technical specification. Referring to FIG. 1, the video decoding apparatus of H.264 AVC may comprise syntactic analyzer 11, Entropy decoder 12, inverse transformer 13, motion vector calculator 14, predictor 15, and deblocking filter 16.

These hardware modules process the compressed video in sequence so as to perform decompression and recover original image data. The syntactic analyzer 11 parses the compressed video so as to obtain motion vector and coding type for each of coding unit. The coding units are generally image blocks such as macro blocks or sub-blocks, which may be differently implemented according to technical specifications.

Recently, in order to provide crime prevention or proof of criminal evidence, CCTV-based video surveillance systems are widely built. Installing CCTV cameras for each section of area, videos captured by the CCTV cameras are displayed on monitor screens and recorded in storage devices. If monitoring agents finds a scene of crime or accident, he or she may immediately take action in a proper way, or may search video in the storage devices for evidence if necessary.

However, the number of monitoring agents is insufficient to the number of CCTV cameras. In order to effectively accomplish video surveillance with this limited number of personnel, it is inappropriate to simply display CCTV video on monitor screen. Rather, it is preferable to detect movement of object in each CCTV video and then further display something in real-time manner. In this case, the monitoring agents may focus on regions in which movement of object is detected in CCTV video.

By the way, compressed video is being adopted in video surveillance system for the efficiency of storage space. In special, as the number of CCTV cameras rapidly grows and high-definition cameras are usually installed, complicated video compression technologies of higher compression ratio such as H.264 AVC or H.265 HEVC, etc. are being adopted. Conventionally, in order to identify presence or absence of movement in a compressed video, the compressed video shall be decoded so as to obtain reproduced video, i.e., the original video data which has been decompressed and then to be image processed.

FIG. 2 is a flow chart illustrating a procedure of extracting region of moving object in compressed video in conventional video analysis solutions.

Referring to FIG. 2, the compressed video shall be decoded by H.264 AVC or H.265 HEVC, etc. (S10), and then image frames of reproduced images shall be downscale resized into smaller images, e.g., 320×240 (S20). The downscale resizing is performed in order to reduce computing load in following steps. Then, differential images shall be obtained out of the resized frame images, and then moving objects shall be extracted by image analysis (S30).

In conventional solutions, decoding of compressed video and downscale resizing, and image analysis shall be processed in order to extract moving objects. These are very complicated processing, which limits the capacity of video analysis server in conventional video surveillance systems. Currently, the maximum number of CCTV channels which a high-performance video analysis server can deal with is sixteen (16) in general. Because pluralities of CCTV cameras are being installed, video surveillance system requires pluralities of video analysis servers, which causes problems such as increased cost and difficulty in physical space.

### DISCLOSURE OF INVENTION

### Technical Problem

In general, it is an object of the present invention to provide a technology of effectively extracting regions of moving object in compressed video, e.g., H.264 AVC or H.265 HEVC, etc.

More specifically, it is another object of the present invention to provide a technology of extracting regions of moving object in compressed, regions in which substantial movement exists, based on syntax information, e.g., motion vector and coding type, without conventional complicated image processing such as video stream decoding or image analysis, which renders the efficiency of extracting regions of moving object improved.

### Technical Solution

In order to achieve the object as above, the syntax-based method of extracting region of moving object in compressed video comprises: a first step of parsing motion vector and coding type for coding unit of the compressed video; a second step of obtaining motion vector accumulation for a predetermined time-period for each of a plurality of image blocks which constituting the compressed video; a third step of comparing the motion vector accumulation with a predetermined first threshold for the plurality of image blocks; and a fourth step of marking as region of moving object some of the image blocks which having the motion vector accumulation higher than the first threshold.

Further, the method of extracting region of moving object according to the present invention may further comprise: a fifth step of identifying a plurality of image blocks (hereinafter referred to as ‘neighboring blocks’) around the region of moving object; a sixth step of comparing motion vectors of the plurality of neighboring blocks with a predetermined second threshold; a seventh step of marking as region of moving object some of the neighboring blocks which having motion vector higher than the second threshold; and an eighth step of marking as region of moving object some of the neighboring blocks whose coding type being Intra Picture.

Further, the method of extracting region of moving object according to the present invention may further comprise: a ninth step of performing interpolation to the plurality of regions of moving object; and a tenth step of displaying the region of moving object distinctively from normal video in reproduced screen of the compressed video.

In the present invention, the image blocks which constituting the compressed video may preferably comprise macro blocks and sub-blocks. Further, the predetermined time-period for the motion vector accumulation may be preferably 500 msec, the predetermined first threshold may be preferably more than 20, and the predetermined second threshold may be preferably 0.

Further, the non-transitory computer-readable medium according to the present invention contains in a computer device a program code which executes the syntax-based method of extracting region of moving object in compressed video as above.

### Advantageous Effects

The present invention may provide an advantage of effectively extracting regions of moving object in compressed video, e.g., CCTV cameras generating. The present invention may provide more or less 20 times better performance than conventional video analysis servers by extracting regions of moving object without complicated processing such as video decoding, downscale resizing, differential image obtaining, and image analysis, etc.

### BRIEF DESCRIPTION OF THE DRAWINGS

FIG. 1 is a block diagram illustrating the general constitution of a video decoding apparatus.

FIG. 2 is a flow chart illustrating a conventional procedure of extracting region of moving object in compressed video.

FIG. 3 is a flow chart illustrating an overall procedure of extracting region of moving object in compressed video according to the present invention.

FIG. 4 is a flow chart illustrating an embodiment of the procedure of detecting effective movement in compressed video in the present invention.

FIG. 5 is a view illustrating an example of the result of performing the procedure of detecting region of effective movement on a CCTV monitoring screen according to the present invention.

FIGS. 6 and 7 are partial enlargement views of important parts in FIG. 5.

FIG. 8 is a flow chart illustrating an embodiment of the procedure of detecting boundary area of region of moving object in the present invention.

FIG. 9 is a view illustrating an example of the result of performing the procedure of detecting boundary area of region of moving object according to the present invention.

FIGS. 10 and 11 are partial enlargement views of important parts in FIG. 9.

FIG. 12 is a view illustrating an example of the result of performing interpolation so as to make up regions of moving object in the present invention.

FIGS. 13 and 14 are partial enlargement views of important parts in FIG. 12.

### EMBODIMENT FOR CARRYING OUT THE INVENTION

The present invention shall be described in detail as below with referring to the accompanying drawings.

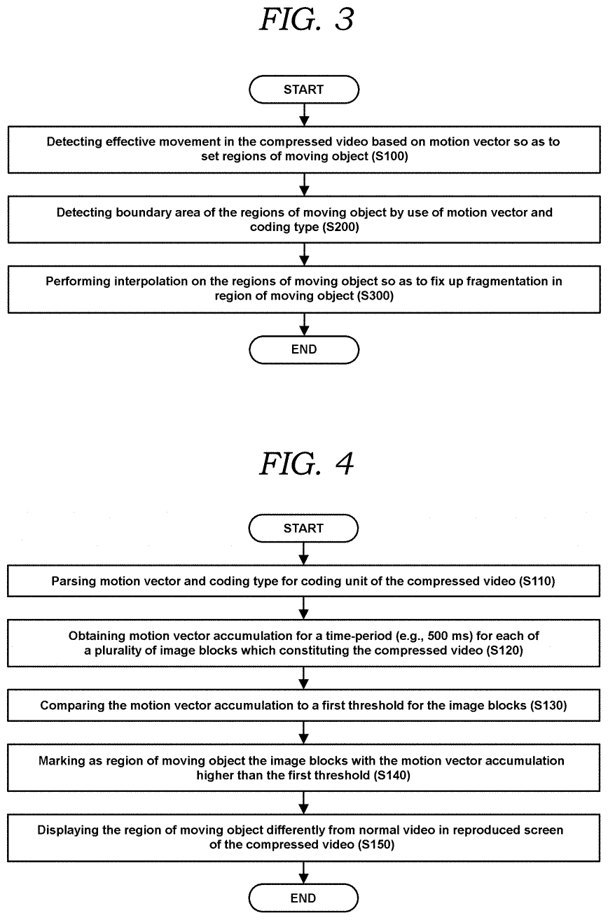

FIG. 3 is a flow chart illustrating an overall procedure of extracting region of moving object in compressed video according to the present invention. The method of extracting region of moving object according to the present invention may be preferably performed by a video analysis server of a system which handling a sequence of compressed video, e.g., CCTV video surveillance system.

In the present invention, the regions of moving object may be extracted from compressed video, without necessity of decoding compressed video, but by use of motion vector and coding type information of each of image blocks, i.e., macro blocks or sub-blocks, etc. which are obtained by bit-stream parsing of the compressed video. However, the present invention shall not be constructed as limited to embodiments in which apparatus or software according to the present invention would not or must not decode the compressed video.

The concept of extracting region of moving object according to the present invention will be described below with reference to FIG. 3.

Step (S100): First, effective movements to which substantial meaning may be given are detected in the compressed video based on motion vector of the compressed video. Then, the image regions in which the effective movements are detected are set as regions of moving object.

For this purpose, motion vector and coding type is parsed for coding units of the compressed video according to video compression standard such as H.264 AVC or H.265 HEVC, etc. The size of the coding unit is usually more or less 64×64 pixel or 4×4 pixel, and may be flexibly configured.

For each of image blocks, motion vector is accumulated for a predetermined time-period (e.g., 500 msec), and then the motion vector accumulation is checked whether it is higher than a predetermined first threshold (e.g., 20). When an image block which passes the check is found, it is regarded that effective movement is found in the image block, and accordingly the image block is marked as region of moving object. By use of the check above, any motion vector whose accumulation value for a specific time-period fails to be higher than the first threshold shall be ignored under estimating that corresponding change in video is rather small.

Step (S200): Then, for the regions of moving object which have been detected in the aforesaid (S100), the extent of boundary area is detected by use of motion vector and coding type. For this purpose, each of a plurality of image blocks which are located adjacent around the image blocks which have been marked as region of moving object is investigated. When its motion vector is higher than a second threshold (e.g., 0) or when its coding type is Intra Picture, the corresponding image block is also marked as region of moving object. Effectively, through this procedure, the corresponding image block become to form a single lump with a region of moving object this is detected in the aforesaid (S100).

If an image block which having more or less movement is found around the regions of moving object which having effective movement, the image block may be also marked as region of moving object, with understanding that the image block is likely to be a single lump with one of the aforesaid regions of moving object. Further, because motion vector is unavailable for Intra Picture, it is impossible to perform checking by use of motion vector. In this regards, Intra Pictures which are located adjacent to image blocks which have already been detected as region of moving object may be set to region of moving object.

Step (S300): The interpolation is performed on the regions of moving object which have been detected in the aforesaid (S100) and (S200) so as to fix up fragmentation in region of moving object. In the previous procedure, regions of moving object have been checked in the unit of image block. Accordingly, although it is actually a single moving object (e.g., human), due to some unmarked image blocks being sparsely mixed between regions of moving object, the single moving object may be fragmented into a plurality of regions of moving object. Therefore, if one or small number of unmarked image blocks are found with being surrounded by a plurality of marked image blocks, they are also marked as region of moving object.

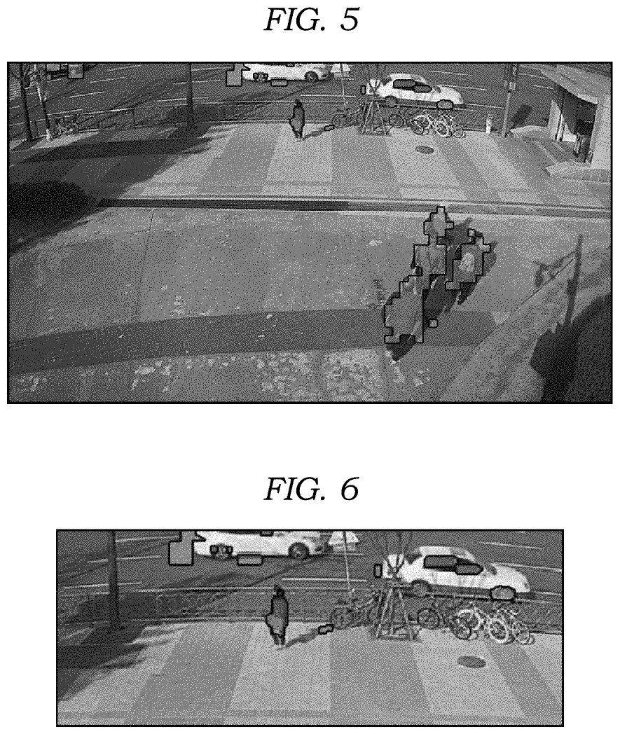

FIG. 4 is a flow chart illustrating an embodiment of the procedure of detecting effective movement in compressed video in the present invention. FIG. 5 is a view illustrating an example of the result of performing the procedure of detecting region of effective movement according to the present invention.

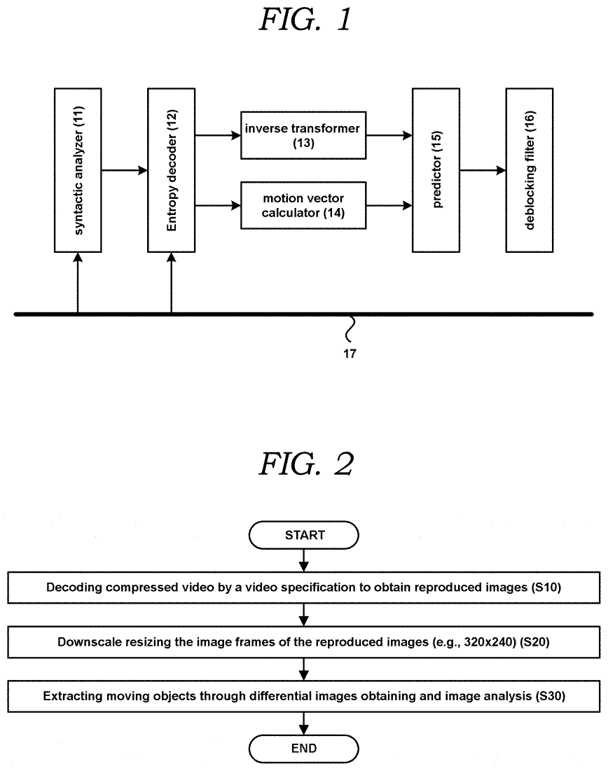

Step (S110): Firstly, motion vector and coding type is parsed for coding units of the compressed video. Referring to FIG. 1, the video decoding apparatus performs syntactic analysis (header parsing) and motion vector calculation for bit-stream of the compressed video by a video compression standard such as H.264 AVC or H.265 HEVC, etc. By this procedure, motion vector and coding type is parsed for coding units of the compressed video.

Step (S120): The motion vector accumulation for a predetermined time-period (e.g., 500 ms) is obtained for each of a plurality of image blocks which constituting the compressed video.

This step is proposed in order to detect any substantially meaningful movement, i.e., effective movement, in the compressed video, e.g., cars in driving, running peoples, and crowds fighting each other. The objects of substantially meaningless movement may not be detected, e.g., shaking leaves, temporal ghosts, and shadows that change slightly by the reflection of light.

For this purpose, motion vector accumulation is obtained by accumulating motion vectors of the unit of one or more image blocks for a predetermined time-period (e.g., 500 msec). The term of ‘image blocks’ may include macro blocks and sub-blocks in this specification.

Steps (S130, S140): For the plurality of image blocks, the motion vector accumulation is compared with a predetermined first threshold (e.g., 20). Then, image blocks with the motion vector accumulation higher than the first threshold are marked as region of moving object.

When an image block having motion vector accumulation higher than a specific number is found, the image block is marked as region of moving object with regarding that some substantially meaningful movement, i.e., effective movement, has been found in that image block. For example, any movement to which monitoring agents of video surveillance system worth paying attention, e.g., a person who is running, may be selectively detected. On the other hand, if any motion vector whose accumulation value for a specific time-period fails to be higher than the first threshold shall be ignored in detecting procedure under estimating that change in video is rather small.

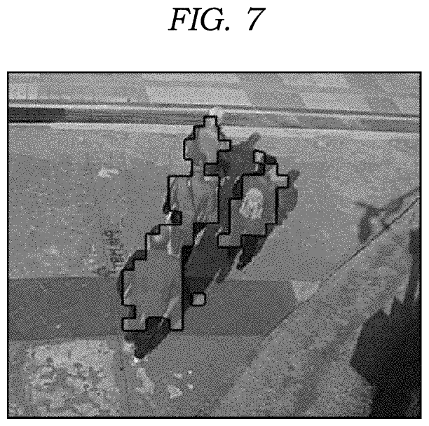

Step (S150): The region of moving object is displayed distinctively from normal video in reproduced screen of the compressed video. FIG. 5 is a view illustrating an example of the result of performing the procedure of detecting region of effective movement on a CCTV monitoring screen according to the present invention. In the FIG. 5, a plurality of image blocks with the motion vector accumulation higher than the first threshold are marked as region of moving object, and are displayed as bold-line boxes on monitor screen. FIGS. 6 and 7 are partial enlargement views of important parts in FIG. 5. Referring to FIGS. 5 to 7, sidewalk blocks, roads, and shade parts are not marked as region of moving object, whereas walking peoples or cars in driving are marked as region of moving object. In this specification, the regions of moving object are represented with bold-line block. However, in CCTV monitor screen, the regions of moving object may be preferably represented by a color by which monitoring agents may immediately identify the region of moving object.

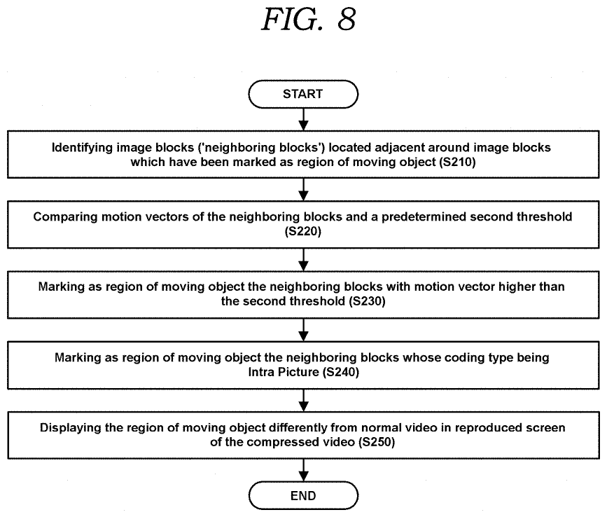

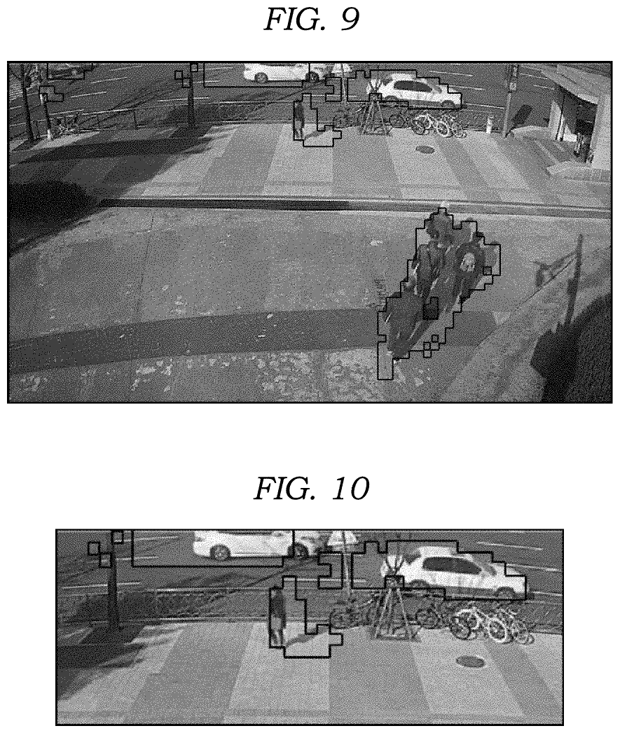

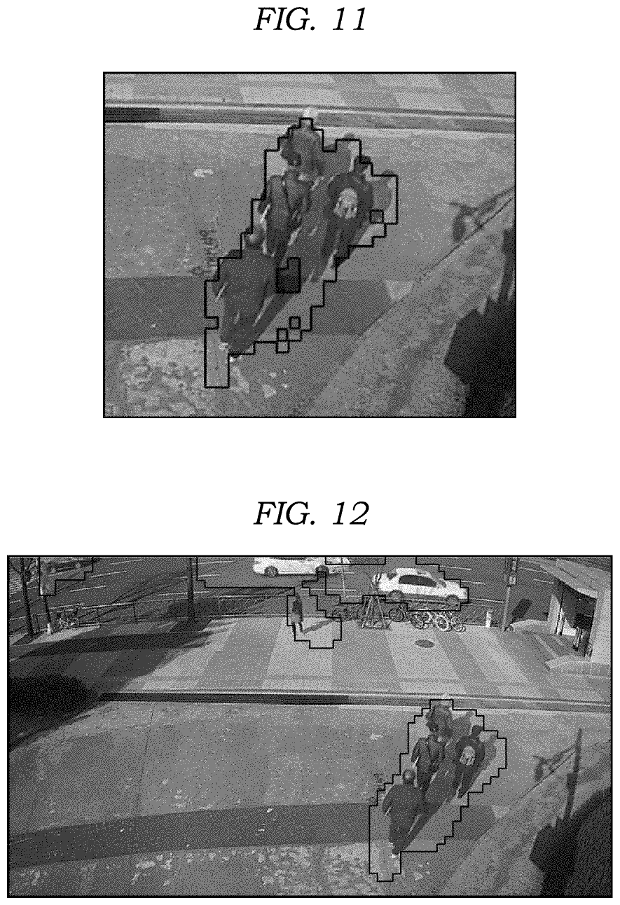

FIG. 8 is a flow chart illustrating an embodiment of the procedure of detecting boundary area of region of moving object in the present invention. FIG. 9 is a view illustrating an example of the result of performing the procedure of detecting boundary area of region of moving object according to the present invention. FIGS. 10 and 11 are partial enlargement views of important parts in FIG. 9.

Referring to FIGS. 5 to 7, it may be found that moving objects have been inappropriately marked, that is, only a part of moving objects are marked. When examining walking peoples or cars in driving, it may be identified that not all of those objects but only some of their blocks are marked. Further, it is also found that more than one regions of moving object have been marked for only one moving object. That means that the criteria in (S100) of marking region of moving object is very useful in filtering out normal regions, but also is too strict.

Therefore, it is necessary to investigate the surroundings of regions of moving object so as to detect the boundary of moving objects.

Step (S210): First, it is identified a plurality of image blocks which are located adjacent around the image blocks which have been marked as region of moving object in the aforesaid (S100). For convenience, they are referred to as ‘neighboring blocks’ in this specification. These neighboring blocks are included in a part which has not been marked as region of moving object in (S100). In the procedure of FIG. 8, the neighboring blocks are further investigated in order to try to find any of the neighboring blocks may be included in the boundary of the regions of moving object.

Steps (S220, S230): The values of motion vectors of the plurality of neighboring blocks are compared with a predetermined second threshold (e.g., 0). Then, some of the neighboring blocks which having motion vector higher than the second threshold shall be marked as region of moving object. If some image blocks are located adjacent to a region of moving object of which substantially effective movement being confirmed and more or less movement is found in the image blocks, when considering the characteristics of shooting video, the image blocks are likely to be a single lump with the region of moving object. Therefore, these neighboring blocks are also marked as region of moving object.

Step (S240): Further, some of the plurality of neighboring blocks whose coding type is Intra Picture shall be marked as region of moving object. The motion vector is unavailable for Intra Picture, which render it impossible to check based on motion vector whether any movement is present or not in the neighboring blocks of Intra Picture. In this case, it is safer to let the configuration of region of moving object of the image blocks which have already been detected as region of moving object into their adjacent Intra Picture.

Step (S250): The region of moving object is displayed distinctively from normal video in reproduced screen of the compressed video. FIG. 9 is a view illustrating an example of the result of performing the procedure of detecting boundary area in the present invention, wherein a plurality of image blocks which have been marked as region of moving object in the procedure above are displayed as bold-line boxes on monitor screen. Referring to FIGS. 10 and 11, it is discovered that the regions of moving object of FIGS. 10 and 11 are extended further around the box-marked regions of moving object of FIGS. 6 and 7, by which the regions of moving object are about to completely cover moving objects.

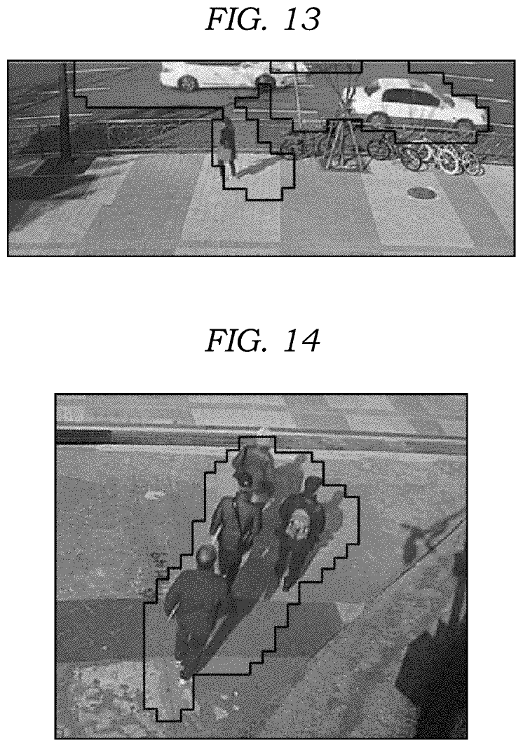

FIG. 12 is a view illustrating an example of the result of performing interpolation so as to make up regions of moving object in the present invention. FIGS. 13 and 14 are partial enlargement views of important parts in FIG. 12.

Step (S300) is a procedure of performing interpolation to the regions of moving object which are marked in the aforesaid (S100) and (S200) so as to fix up fragmentation of region of moving object. Referring to FIGS. 9 to 11, unmarked image blocks are found in the space between box-displayed regions of moving object. When unmarked image blocks are sparsely mixed like this, it is difficult to determine whether these are separate moving objects or these shall be regarded a single lump. In special, these unmarked image blocks become to form a mottled display on monitor screen of CCTV video surveillance system, which renders monitoring agents unable to promptly figure out the CCTV video. Further, if region of moving object is fragmented, the result of (S400) may become inaccurate.

Accordingly, in the present invention, if one or small number of unmarked image blocks are found with being surrounded by a plurality of image blocks which are marked as region of moving object, they are also marked as region of moving object, which is referred as ‘interpolation’. Referring to FIGS. 12 to 14 with comparing FIGS. 9 to 11, the unmarked image blocks between regions of moving object are marked as region of moving object. By the interpolation, the detection result of moving objects may become more intuitive and accurate for the reference purpose of monitoring agents.

Further, the present invention may also be embodied as computer readable codes on a non-transitory computer-readable medium. The non-transitory computer-readable medium is any data storage device that can store data which may be thereafter read by a computer system, which include hard disks, SSDs, CD-ROMs, NAS, magnetic tapes, web-disks, and cloud disks. The non-transitory computer-readable medium can also be distributed over network coupled computer systems so that the computer readable code is stored and executed in a distributed fashion.

1. A syntax-based method of extracting region of moving object in compressed video, the method comprising:
a first step of parsing bit-stream of the compressed video so as to obtain motion vector and coding type for coding unit of the compressed video;
a second step of obtaining motion vector accumulation for a predetermined time-period for each of a plurality of image blocks which constituting the compressed video;
a third step of comparing the motion vector accumulation to a predetermined first threshold for the plurality of image blocks; and
a fourth step of marking as region of moving object some of the image blocks which having the motion vector accumulation higher than the first threshold.

2. The method according to claim 1, the method, after the fourth step, further comprising:
a fifth step of identifying a plurality of image blocks (hereinafter referred to as ‘neighboring blocks’) around the region of moving object;
a sixth step of comparing motion vectors of the first step of the plurality of neighboring blocks with a predetermined second threshold; and
a seventh step of marking as region of moving object some of the neighboring blocks which having motion vector higher than the second threshold in the comparison of the sixth step.

3. The method according to claim 2, the method, after the seventh step, further comprising:
an eighth step of further marking as region of moving object some of the neighboring blocks whose coding type being Intra Picture.

4. The method according to claim 3, the method, after the eighth step, further comprising:
a ninth step of performing interpolation to the plurality of regions of moving object so as to further mark as region of moving object unmarked image blocks which being surrounded by region of moving objects, wherein the number of unmarked image blocks is less than a predetermined number.

5. The method according to claim 4, wherein the image blocks comprises macro blocks and sub-blocks.

6. A non-transitory computer-readable medium containing program code which executes the syntax-based method of extracting region of moving object in compressed video according to any one of claims 1 to 5.
